(19) United States
(12) Patent Application Publication
(10) Pub. No.: US 2010/0245234 A1
(43) Pub. Date: Sep. 30, 2010

(54) Portable Electronic Device with Low Dexterity Requirement Input Means

(75) Inventors: Cheol Woo Park, Chicago, IL (US); Adam Cybart, McHenry, IL (US); Michiel S. Knoppert, Chicago, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/415,550

(22) Filed: Mar. 31, 2009

(51) Int. Cl. G09G 5/00

(52) U.S. Cl. 345/156

(57) ABSTRACT

A handheld-size electronic device is provided with a display screen, or front housing or bezel surrounding the display screen, that is moveably mounted to the remainder of the electronic device. Detectors are provided for detecting movement of the display screen, or surrounding front housing part, and a microprocessor coupled to the detectors controls the electronic device based on that movement. This mode of user input allows users to control the electronic device with a quick hand motion and without requiring the level of focus that is typically required to operate the small buttons of a wireless device. This mode of user input can be use for various purposes including, for example, controlling digital music playback.

### FIELD OF THE DISCLOSURE

The present disclosure relates generally to handheld-size electronic devices such as wireless communication handsets, digital music players, Global Positioning System devices, handheld electronic game consoles, and the like.

### BACKGROUND

Recently, many more people have started using so-called “smartphones”. Smartphones generally have relatively powerful microprocessors and a somewhat open software architecture that allows a variety of software applications to be installed according to each user's desires. The smartphone software, whether pre-installed or user installed is generally more sophisticated than the software installed on less capable handsets. In order to provide for user interaction with this more capable software, smartphones generally have a full QWERTY keyboard or are able to emulate a QWERTY keyboard using a touch screen. Operating the small QWERTY keyboard or other small real or virtual buttons of a smartphone requires a relatively high level of attention and focus on the part of the user.

One issue with the small QWERTY keyboard and other small controls of portable wireless devices is that if the user would like to input some command quickly under circumstances in which it is inconvenient for the user to focus full attention on the device, there may be some doubt, due to the small size of the controls, as to whether a particular button was effectively pressed and the intended command received. For example if a user is using a digital music playback functionality of a handset while jogging with the handset held in an armband, it would be inconvenient for the user to bring the handset to a position in which the QWERTY keyboard could be viewed and to enter commands using the QWERTY keyboard.

There have been some efforts in the past to address such concerns. For example U.S. Pat. No. 6,710,518 to Morton et al. proposes a portable electronic device with a transducer for generating an impulse in response to a user's actuation of a button—whether it is an actual button or a button emulated on a touch screen. The impulse, which is felt by the user, provides reassurance to the user that a button actuation has registered.

Another effort to address the aforementioned concerns is found in U.S. Pat. No. 7,027,840 which provides for using the speaker of a wireless handset to detect a user's tapping that handset in order that the tapping may be construed as a user command, e.g., to mute ringing of the handset. The '840 patent is noteworthy in that it is meant to allow the user to enter a command without the user's having to focus the level of attention needed to operate a QWERTY keyboard.

The system disclosed in the '840 patent is somewhat limited in the type of user input that can be accommodated. A single command which may be equated to a single bit Boolean field can be entered, e.g., IF tap detected THEN do X.

What is needed then is system that can accept user input under circumstances in which it is inconvenient for the user to use the QWERTY keyboard, and provide for accepting user input in a manner that does not require the level of focus that operating a QWERTY keyboard or other small buttons requires and also provides versatility and power in terms of the variety of commands that may be entered.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a depiction of a user using an electronic device according to the present disclosure while jogging and listening to music played by the electronic device;

FIG. 2 is a front view of electronic device with a moveable display screen user input mechanism in two positions;

FIG. 3 is a fragmentary cross sectional view of an electronic device with a moveable display screen user input mechanism according to a first embodiment;

FIG. 4 is a fragmentary cross sectional view of an electronic device with a moveable display screen user input mechanism according to a second embodiment;

FIG. 5 is a fragmentary cross sectional view of an electronic device with a moveable display screen user input mechanism according to a third embodiment;

FIG. 6 is a fragmentary cross sectional view of an electronic device with a moveable display screen user input mechanism according to a fourth embodiment;

FIG. 7 is a front view of an electronic device with a movable front housing part user input mechanism in two positions;

FIG. 8 is a fragmentary cross sectional view of an electronic device with a moveable front housing part user input mechanism according to a fifth embodiment; and

FIG. 9 is an exploded view of an electronic device with a moveable front housing part user input mechanism according to a sixth embodiment.

FIG. 10 is an exploded view of a center position biasing mechanism used in the electronic device shown in FIG.9.

FIG. 11 is a perspective view of the center position biasing mechanism shown in FIG. 10 in an assembled state;

FIGS. 12-13 are two cross sectional views of the center position biasing mechanism shown in FIGS. 10-11;

FIG. 14 is a cross sectional view of an electronic device that includes a display and a moveable front housing part about the display that serves as user input mechanism;

FIGS. 15-16 are two views of a piece of flex circuitry that interconnects two relatively moveable parts of electronic devices according to various embodiments;

FIG. 17 is an exploded view of an electronic device that has a tilting display screen that serves as a user input mechanism according to a seventh embodiment;

FIG. 18 is a block diagram of an electronic device according to various embodiments;

FIG. 19 is flowchart of a method of operating an electronic device according to various embodiments; and

FIG. 20 is a prior art smartphone with a QWERTY keyboard.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A handheld-size electronic device is provided with a display screen, or front housing bezel surrounding the display screen, that is moveably mounted to the remainder of the electronic device. Detectors are provided for detecting movement of the display screen, or surrounding bezel, and a microprocessor coupled to the detectors controls the electronic device based on that movement. This mode of user input can be use for various purposes including for example controlling digital music playback. This mode of user input allows users to control the electronic device with a quick hand motion and without requiring the level of focus that is typically required to operate the small buttons of a wireless device.

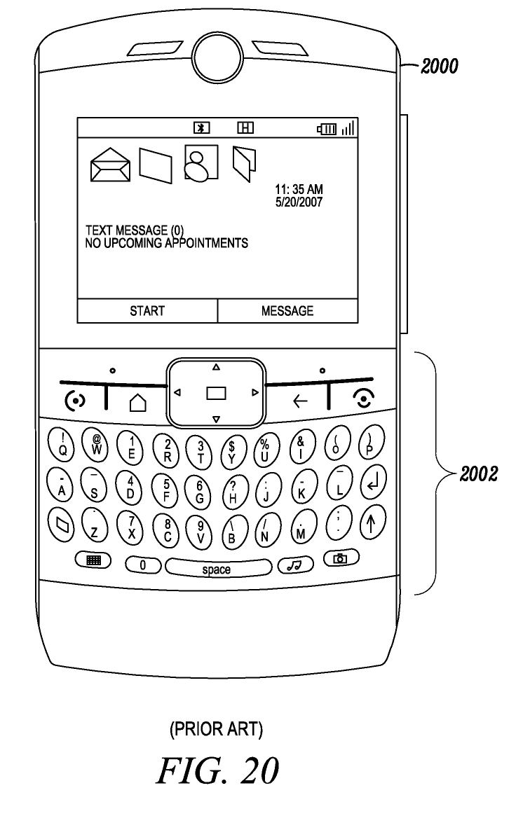

FIG. 20 is a prior art smartphone 2000 with a QWERTY keyboard 2002. In order to use the QWERTY keyboard, a relatively high level of focus and eye hand coordination is required. Moreover operating the QWERTY keyboard ordinarily involves both hands in holding the device and pressing the keys of the QWERTY keyboard. Other keys are also typically actuated with both hands engaged in holding and/or pressing. Some smartphones emulate a QWERTY keyboard on a touch screen in lieu of a real QWERTY keyboard. Operating an emulated keyboard is similarly demanding.

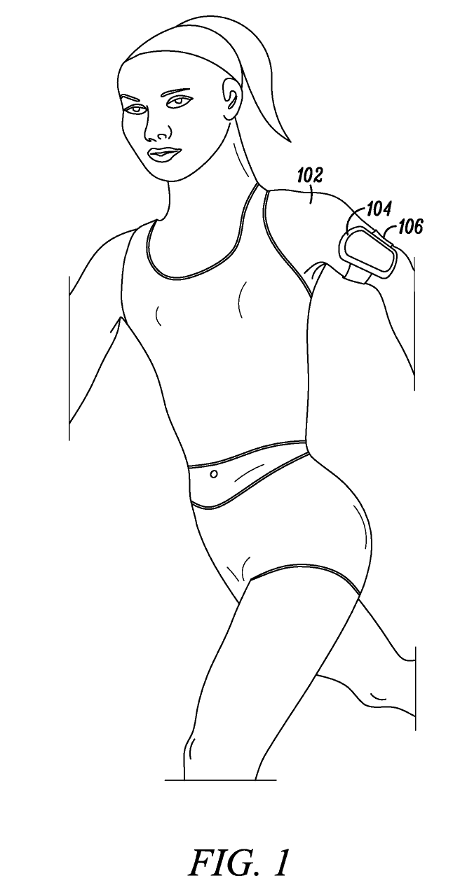

FIG. 1 is a depiction of a user 102 using an electronic device 104 according to the present disclosure while jogging and listening to music played by the electronic device 104. The device 104 is supported by an armband 106 on the user's 102 arm. In order to control certain functions of the device 104, the user 102 only has to reach over and with a quick movement thrust the display screen (or alternatively the front housing surrounding the display screen) in a particular direction, e.g., up, down, left, or right, in order to control the operation of the electronic device 104. The display screen is biased to automatically return to its undisturbed position (a neutral position) and is prepared to receive additional thrusts.

Each direction of movement can be used to input a different control function, e.g., increasing or decreasing volume by upward and downward thrusts and controlling track position by leftward and rightward thrusts. The device 104 can also be controlled in the same way while it is held in a hand, a pocket, a purse, or a belt-worn holder. The user control action is easily performed without the user even having to look at the device. Although four Cartesian directions are described for the sake of simplicity, non-Cardinal directions can also be accommodated. Additionally, fewer than four directions can be implemented. For example, track advance and track reverse could be implemented using only rightward and leftward thrusts (with a final track re-circulating forward to an initial track, and an initial track re-circulating backwards to a final track). As another example, an implementation might accept only up and down thrusts.

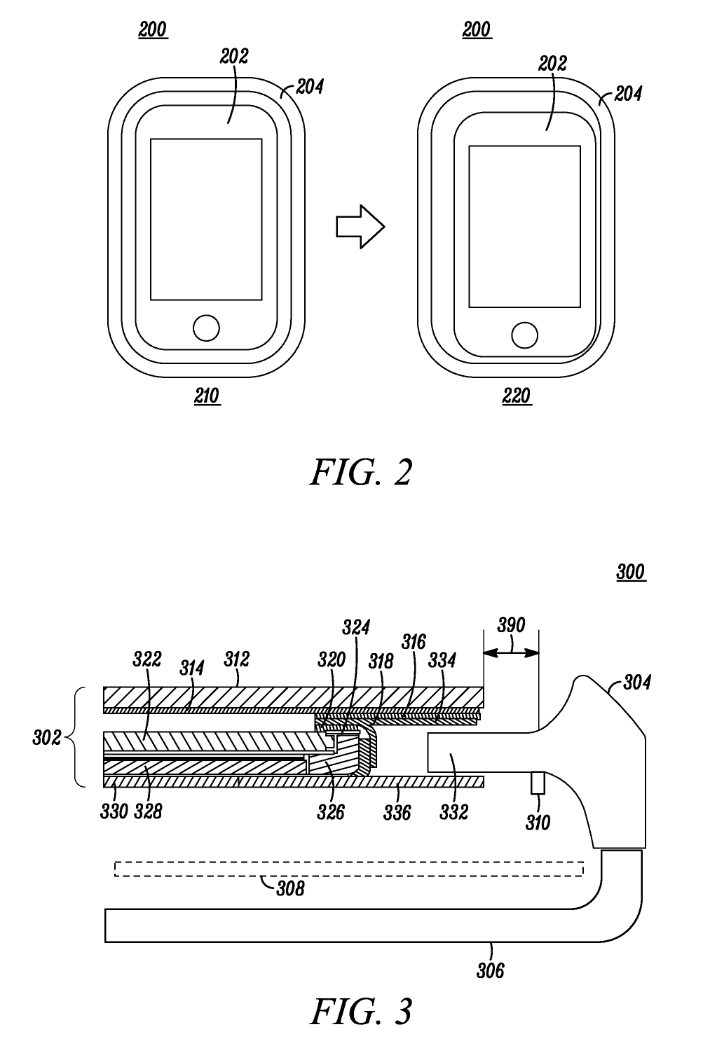

FIG. 2 is a front view of an electronic device 200 with a moveable display screen 202 user input mechanism in two positions. In the left hand depiction 210 the display screen 202 is in a centered rest position relative to a front housing 204 and in the right hand depiction 220 the display screen 202 has been thrust to the right relative to the front housing 204 in order to actuate a control function (e.g., skip forward to a next music track). The display screen 202 serves as a four way directional control switch in this example.

FIG. 3 is a fragmentary cross sectional view of an electronic device 300 with a moveable display screen 302 user input mechanism according to a first embodiment. Note that this is one partial cross section of one quadrant of the electronic device 300. Additional cross sections would be similar in construction and have different orientations. The display screen 302 is an assembly that is mounted to a front housing part 304 of the device 300. The device 300 also includes rear housing part 306 and a printed circuit board 308 enclosed between the front housing part 304 and the rear housing part 306. At least one detector 310 (e.g., four detectors, one of which is visible in FIG. 3) is provided for sensing movement of the display screen 302 and can be mounted on the front housing part. Alternately, the detector 310 can be mounted on the moveable display screen or other locations. The detector 310 can for example be a Hall Effect sensor, an optical sensor, or a capacitive sensor.

The display screen has a front lens 312 overlying an anti-splinter layer 314 which is bonded with a first portion of adhesive 316 to a front display bezel 318. The front display bezel 318 is bonded with a second portion of adhesive 320 to a display proper 322 and a gasket 324. The gasket 324 abuts a light guide holder 326 which helps to position a light guide 328 at the rear of the display proper 322. A rear display bezel fits 330 around the back (bottom in the perspective of FIG. 3) of the light guide 328.

The front housing part 304 includes an inwardly (toward the center of the display screen) protruding flange 332 that extends between an outwardly extending portion 334 of the front display bezel and an outwardly protruding portion 336 of the rear display bezel 330. Note that the front lens 312 extends outward beyond the periphery of the display proper 322 in overlapping relation with the inwardly protruding flange 332. The display screen 302 is thus held in a moveable but captive manner by the inwardly protruding portion of the flange 332 of the front housing part 304. The display screen 302 is in an imaginary plane that is parallel to the screen surface (e.g., an X-Y plane of a Cartesian coordinate system that has a Z-axis perpendicular to the display screen 302). A double headed arrow 390 indicates the direction of movement of the display screen 302 in the device fragment shown.

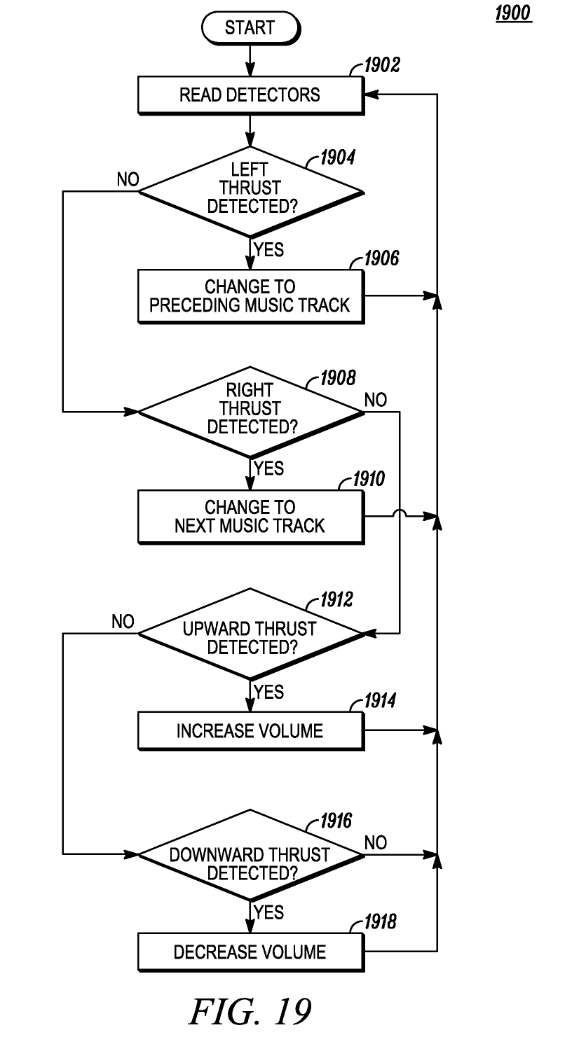

The detectors 310 are coupled to a microprocessor (see FIG. 19) and sense relative movement between the display screen 302 and the front housing part 304 and hence relative to the rear housing part 306 which is attached to the front housing part 304.

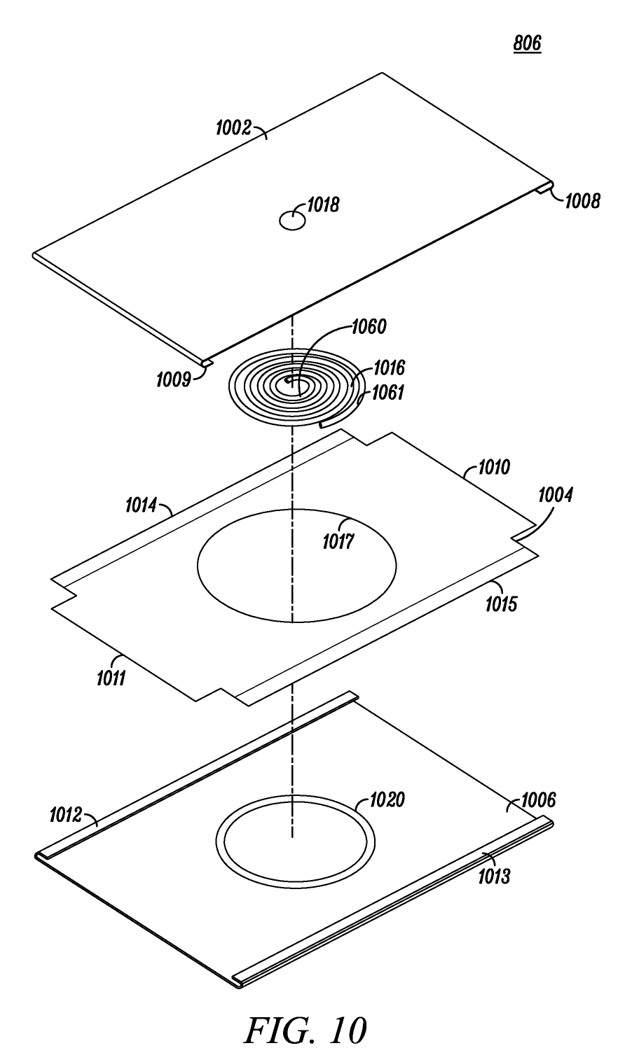

Optionally, one or more springs (see FIG. 10) can be positioned between the display screen 302 and another part of the device 300 in order to bias the display screen 302 to a central rest position. Alternative to the arrangement shown in FIG. 10, a set of coil springs positioned about the periphery of the display screen 302 between the display screen and the front housing part 304 may be used.

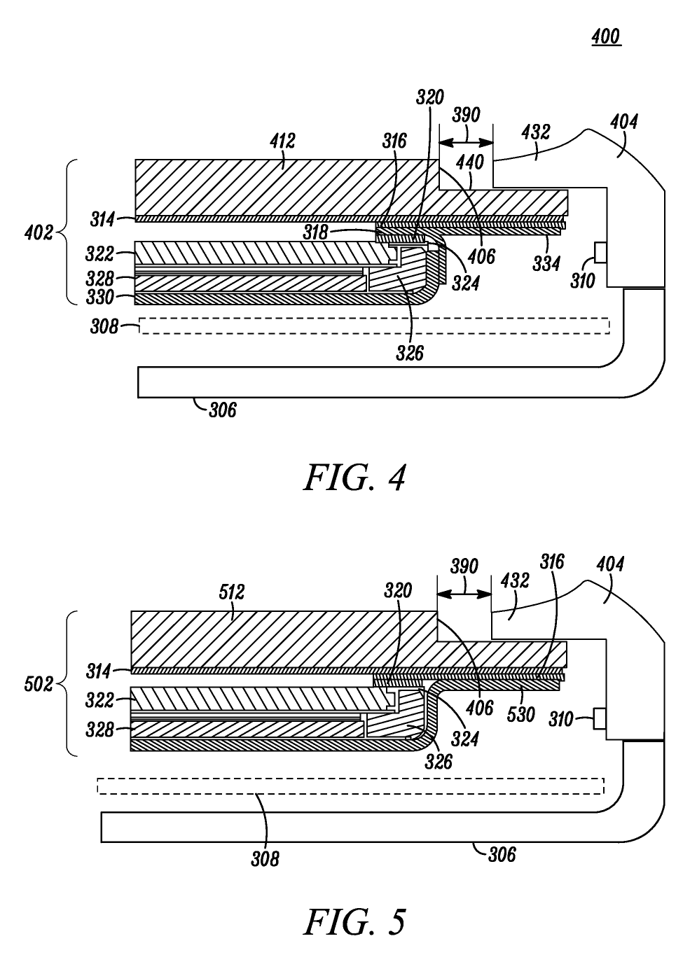

FIG. 4 is a fragmentary cross sectional view of an electronic device 400 with a moveable display screen 402 user input mechanism according to a second embodiment. Note that this is one partial cross section of one quadrant of the electronic device 300. Additional cross sections would be similar in construction and have different orientations. In the embodiment shown in FIG. 4, a front lens 412 includes a thinned peripheral portion 440 that extends under an inwardly protruding flange 432 of a front housing part 404. A vertical surface 406 of the lens that extends upward from an inboard extreme of the thinned peripheral portion of the front housing part 404 acts as a motion stop when it abuts the inwardly protruding flange 432 with which it is vertically aligned. Other elements shown in FIG. 4 are functionally similar to their FIG. 3 counterparts.

FIG. 5 is a fragmentary cross sectional view of an electronic device 500 with a moveable display screen 502 user input mechanism according to a third embodiment. Note that this is one partial cross section of one quadrant of the electronic device 300. Additional cross sections would be similar in construction and have different orientations. In the embodiment shown in FIG. 5, no front display bezel 318 is included but a rear display bezel 530 wraps around the side of the light guide holder 326 and extends peripherally outward along the bottom of the lens 512 to which it is affixed by the first portion of adhesive 316. Other elements shown in FIG. 5 are functionally similar to their FIGS. 3-4 counterparts.

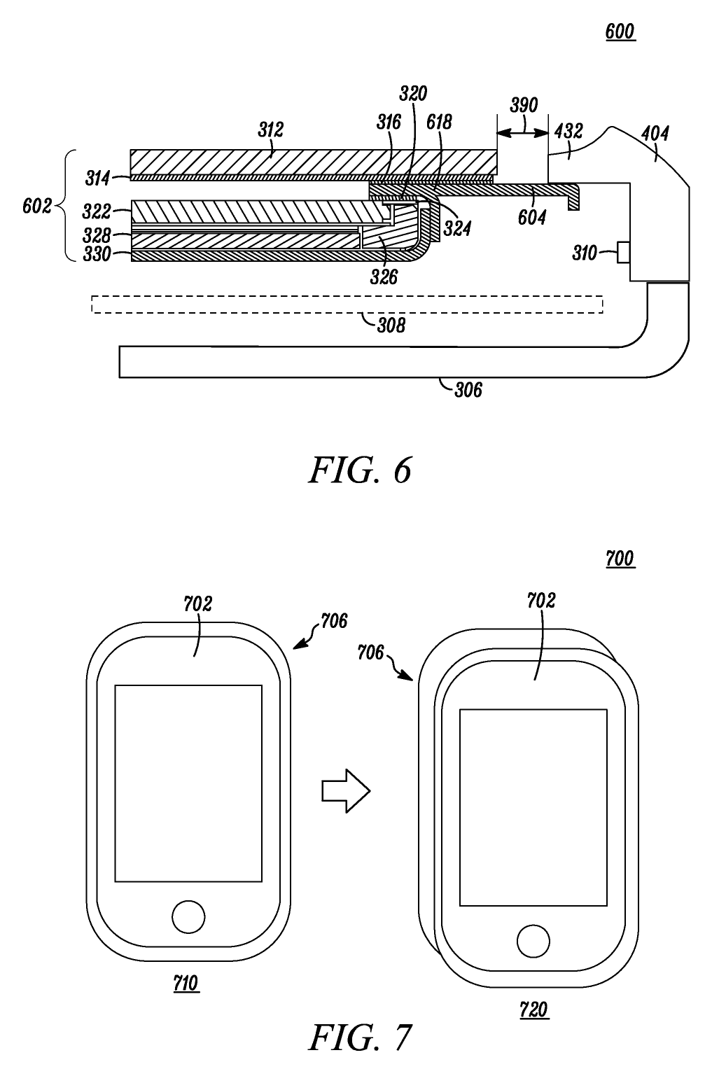

FIG. 6 is a fragmentary cross sectional view of an electronic device 600 with a moveable display screen 602 user input mechanism according to a fourth embodiment. Note that this is one partial cross section of one quadrant of the electronic device 300. Additional cross sections would be similar in construction and have different orientations. In the embodiment shown in FIG. 6 the front display bezel 618 includes a peripheral outward extending portion 604 that extends under the inwardly protruding flange 432 of the front housing part 404. This outward extending portion 604 acts as a motion stop when it abuts an interior surface of the front housing part 404. Other elements shown in FIG. 6 are functionally similar to their FIGS. 3-4 counterparts.

FIG. 7 is a front view of an electronic device 700 with a movable front housing part 702 user input mechanism in two positions. In the depiction at the left 710, the front housing part 702 is centered with respect to a rear housing part 706. It may be biased to the central position by one or more springs. In the depiction at the right 720, the front housing part 702 has been thrust to the lower left by the user. The electronic device 700 can be programmed to respond to thrusting of the front housing part (or display as in embodiments described previously) in a direction other than a Cardinal direction by executing a function that is distinct from those that would be executed when the direction of thrusting is in a Cardinal direction OR to respond by executing commands associated with the two Cardinal directions which the non-Cardinal direction of the thrust bisects. The front housing part 702 and the display screen 202 of FIG. 2 can function as a multidirectional input in this example—analogous to a joystick.

Although rest positions 210, 710 are depicted as having a moveable user input mechanism centered relative to a stationary rear housing, the display screen 202 in the embodiment shown in FIG. 2 and the front housing part 702 in the embodiment shown in FIG. 7 can alternatively be biased to a rest position (neutral position) other than the central position shown.

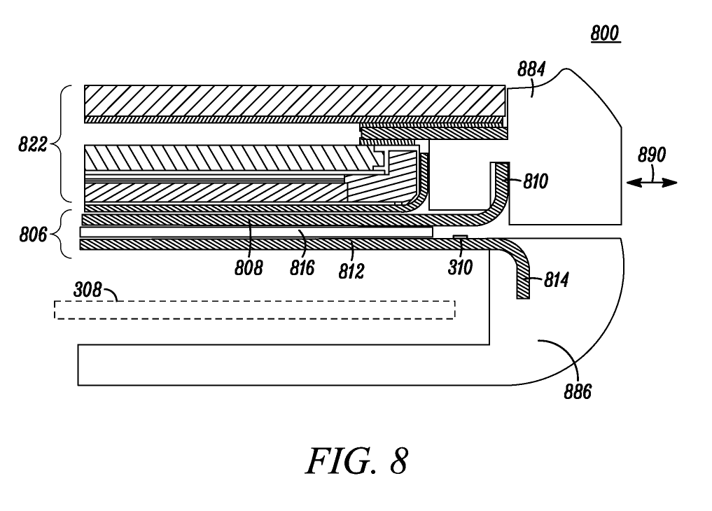

FIG. 8 is a fragmentary cross sectional view of an electronic device 800 with a moveable front housing part 884 user input mechanism according to a fifth embodiment. Note that this is one partial cross section of one quadrant of the electronic device 300. Additional cross sections would be similar in construction and have different orientations. The electronic device 800 includes a rear housing part 886 coupled to the front housing part 884 through a biasing mechanism 806. The biasing mechanism 806 includes an upper plate 808 that includes at least one upwardly bent portion 810 that engages the front housing part 884; a lower plate 812 that includes at least one downwardly bent portion 814 that engages the rear housing part 886; and at least one spring 816 (shown schematically in FIG. 8) that couples the lower plate 812 to the upper plate 808. The front housing part 884 includes a display screen 882 that is stationary relative to the front housing part 884. At least one detector 310 is provided for sensing movement 890 of the front housing part 884 relative to the rear housing part 886 and can be mounted on the lower plate 812 or the rear housing part 886.

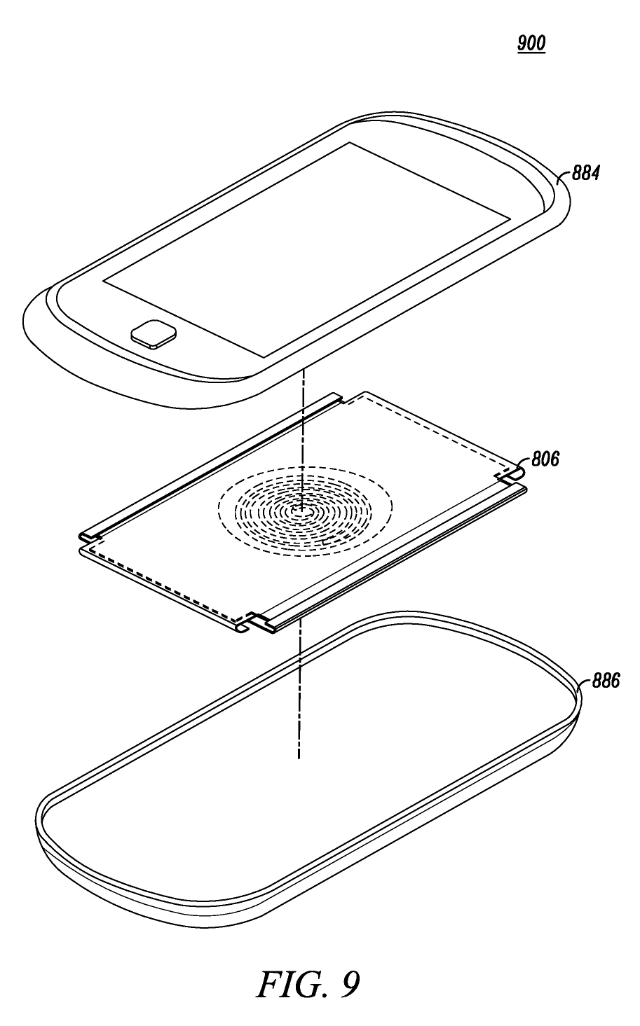

FIG. 9 is an exploded view of an electronic device 900 with a moveable front housing part 884 user input mechanism according to a sixth embodiment. The front housing part 884 is coupled to a rear housing part 886 via a center position biasing mechanism 806. FIG. 10 is an exploded view of a center position biasing mechanism 806 used in the electronic device shown in FIG. 9. The center position biasing mechanism 806 includes an upper plate 1002, a middle plate 1004, and a lower plate 1006. The upper plate 1002 includes folded over top and bottom edges 1008, 1009 that slide over top and bottom extending tabs 1010, 1011 of the middle plate 1004. Similarly the lower plate 1006 includes folded over left and right edges 1012, 1013 that slide over left and right extending tabs 1014, 1015 of the middle plate 1004.

A flat spiral-shaped spring 1016 is positioned in a circular opening 1017 in the middle plate 1004. A center boss 1018 that is attached to the bottom of the center of the upper plate 1002 (and seen in FIG. 10 as though in an X-ray view) engages the center 1060 (inward end) of the spiral spring 1016. A circular boss 1020 that is located about the center of the lower plate 1006 facing the middle plate 1004 engages the periphery 1061 (outer end) of the spiral spring 1016. By the foregoing arrangement, the upper plate 1002 and the lower plate 1006 are coupled to each other in such manner that they may move relative to each other in any compass direction governed by a constraint on the maximum relative displacement and from such movement are always urged by the spiral spring 1016 back to a position in which they are centered relative to each other.

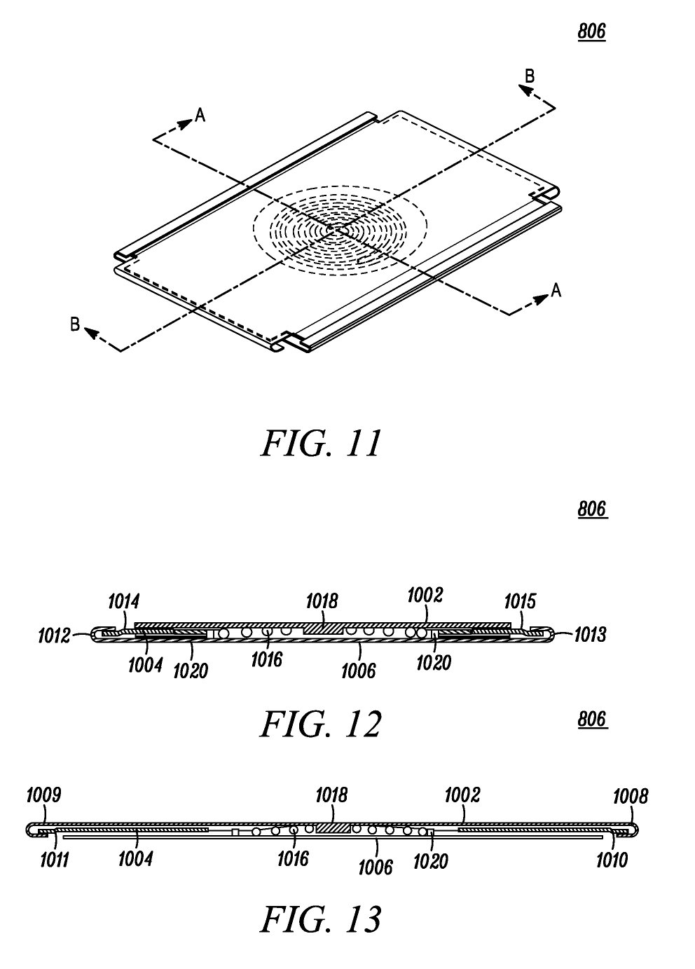

FIG. 11 is a perspective view of the center position biasing mechanism 806 shown in FIG. 10 in an assembled state and FIGS. 12-13 are two cross sectional views of the center position biasing mechanism 806. FIG. 12 corresponds to the section plane designated AA in FIG. 12 and FIG. 13 corresponds to the section plane designated BB in FIG. 12. Elements shown in FIGS. 12-13 are functionally similar to their FIG. 10 counterparts. Although not shown, the upper plate 1002, middle plate 1004, and lower plate 1006 can be provided with oversized holes through which flex circuits, optical fibers, or micro-coax may be run in order to transfer electrical or optical signals from one part of the electronic device 900 to another, e.g., from a circuit board 308 to a display screen 882.

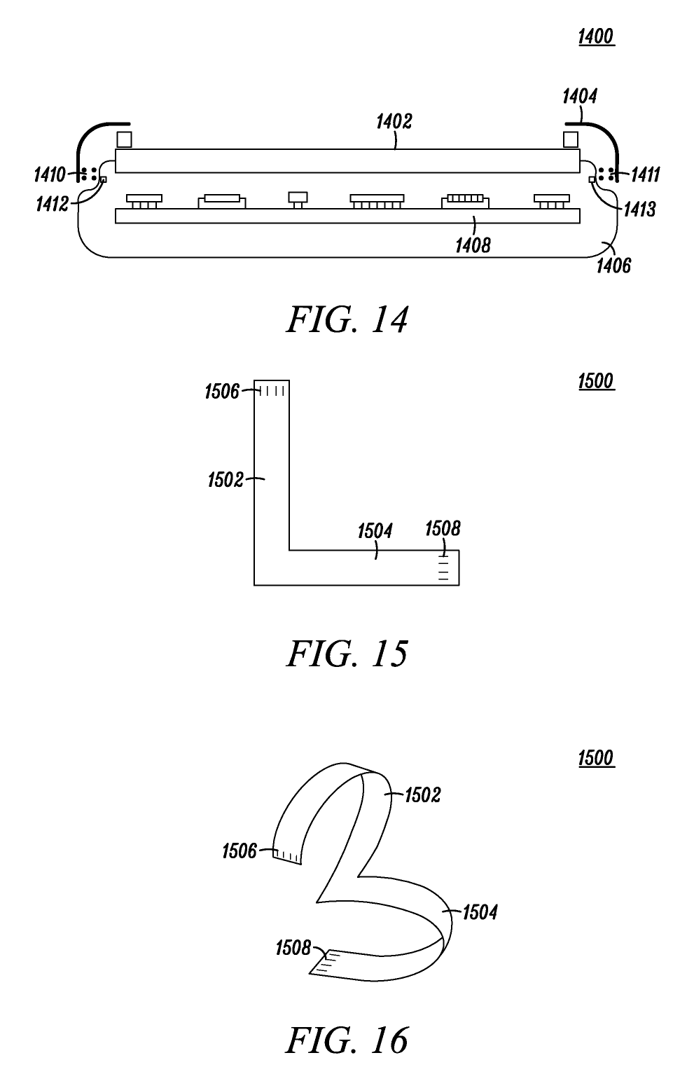

FIG. 14 is a cross sectional view of an electronic device 1400 that includes a display 1402 and a moveable front housing part 1404 about the display that serves as user input mechanism. Note that this is one partial cross section of one half of the electronic device 300. Another cross section would be similar in construction and have a different orientation. The display 1402 is mounted to a rear housing part 1406 that encloses a printed circuit board 1408. The moveable front housing part 1404 is in the form of a bezel that surrounds the display 1402. The moveable front housing part 1404 is mounted to the rear housing part 1406 by a plurality of springs 1410, 1411. A plurality of detectors 1412, 1413 are used to sense movement of the moveable front housing part 1404 by the user, so that movement of the moveable front housing part can be used to control the electronic device 1400.

FIGS. 15-16 are two views of piece of flex circuitry 1500 that interconnects two relatively moveable parts of electronic devices according to various embodiments. For example the flex circuitry 1500 can be used to connect moveable displays of the devices shown in FIGS. 1-14 to fixed printed circuit boards of the devices. In FIG. 15 the piece of flex circuitry 1500 is shown unbent—in a planar configuration. The piece of flex circuitry includes a first arm 1502 and a second arm 1504 arranged to form a right angle. The first arm 1502 includes a first free end 1506 and the second arm 1504 includes a second free end 1508. In FIG. 16 the two arms 1502, 1504 have been flexed into curves that curve through 180° angles. Now when the free ends 1506, 1508 of the piece of flex circuitry 1500 are connected to a PCB and display, respectively, the curves of the flex circuitry will be able to roll slightly allowing for relative movement between the PCB and the display in any compass direction.

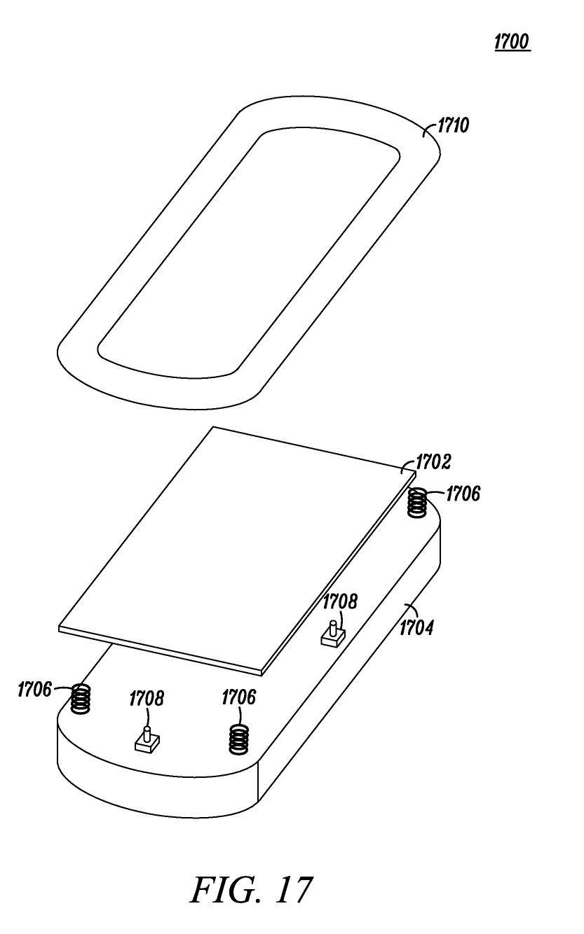

FIG. 17 is an exploded view of an electronic device 1700 that has a tilting display screen 1702 that serves as a user input mechanism according to a seventh embodiment. The tilting display screen 1702 is mechanically coupled to a rear housing part 1704 of the electronic device 1700 by four springs 1706 (three of which are visible in FIG. 17) that are situated near the corners of the display screen 1702. Four detectors 1708 (two of which are visible in FIG. 17) are mounted on the rear housing part 1704 proximate the center of each side of the display screen 1702. A bezel 1710 which mounts to the rear housing part 1704 holds the display screen 1702 against the springs 1706. The bezel 1710 may be snap fit or held by screws (not shown), or affixed by another device or method, to the rear housing part 1704. The screen supported in this way will be able to move in a tilting motion. A user can press different corners or edges of the screen in order to enter different commands. It will not be necessary to press at an exact location as long as the display screen tilts enough to be detected by one or two of the detectors 1708.

The device 1700 can be programmed to interpret the triggering of all detectors 1708 as an ‘OK’ or ‘select’ command. All detectors 1708 can be triggered if the user pushes down the entire display screen 1702 by pressing down at the center of the display screen 1702. Thus the user can for example navigate through a list of icons using presses near edges of the display screen to indicate directional jumps from icon to icon and, when a desired icon has been reached, press the center of the screen to activate a function represented by the icon. Although specific spring and sensor locations have been shown for this embodiment, other implementations may use different locations. For example, springs and sensors may be co-located, or sensors could be at corners while springs are near the center of each side. Additionally, fewer or more springs and sensors can be used.

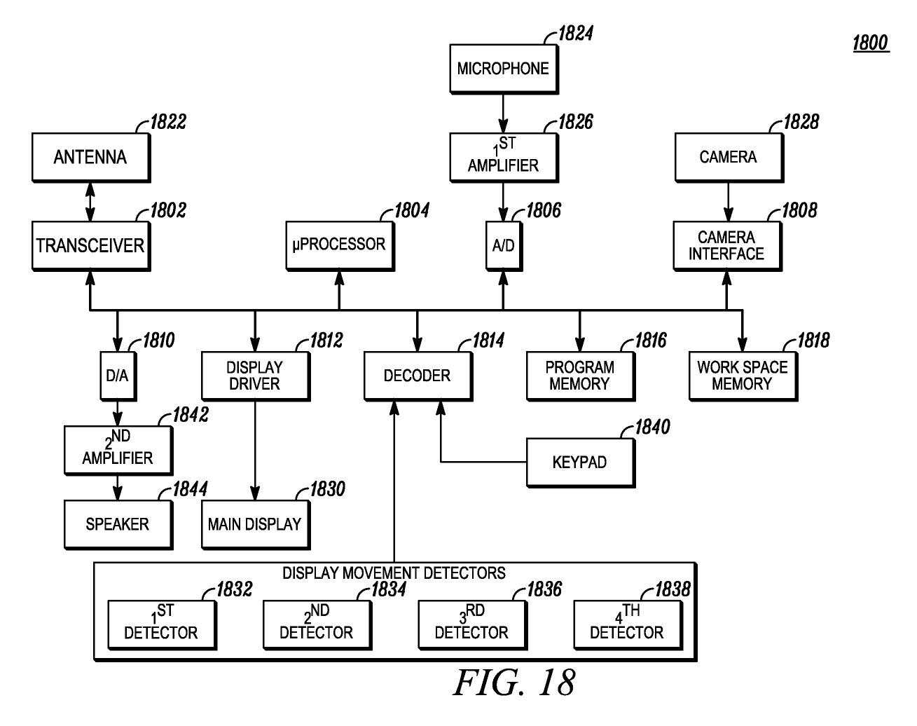

FIG. 18 is a block diagram of an electronic device 1800 according to various embodiments. This embodiment presumes a wireless communication device; however, many other types of handheld electronic devices may be implemented using the concepts disclosed. As shown in FIG. 18 the device 1800 includes a transceiver 1802, a microprocessor 1804, an analog-to-digital converter (A/D) 1806, a camera interface 1808, a digital-to-analog converter (D/A) 1810, a display driver 1812, a decoder 1814, a program memory 1816, and a workspace memory 1818 coupled together through a system bus 1820.

The transceiver 1802 is coupled to an antenna 1822. Radio frequency and/or microwave signals that are modulated with encoded data (e.g., digitized voice audio, text messages, photos, etc.) pass between the transceiver 1802 and the antenna 1822.

The microprocessor 1804 executes control programs and may also perform communication encoding and decoding tasks. Programs executed by the microprocessor 1804 are stored in the program memory 1816. The microprocessor 1804 uses the workspace memory 1818 in executing programs. The microprocessor 1804 is suitably part of a highly integrated micro-controller integrated circuit. The micro-controller suitably includes one or more of the other above mentioned components that are coupled together through the signal bus 1820. The transceiver 1802 and the microprocessor 1804 and optionally other blocks shown in FIG. 11 are embodied in circuits of the printed circuit boards mentioned above.

A microphone 1824 is coupled through a first amplifier 1826 to the A/D 1806. The A/D 1806 is used to digitize a user's spoken words, which are then encoded by a voice encoder (vocoder) component of the microprocessor 1804.

A camera 1828 couples to the microprocessor 1804 through the camera interface 1808. The camera interfaces 1808 reads and digitizes pixel data from the camera 1828, and makes such data available to the microprocessor 1804 for further processing, e.g., image/video compression encoding.

The display driver 1812 drives a display 1830. The display 1830 is moveable relative to a rear housing part as shown in the embodiments of FIGS. 1-17. The display screen is moveable either alone or as part of a front housing part.

The decoder 1814 is coupled to a first through fourth detectors 1832, 1834, 1836, 1838 that are used to detect the movement of the display 1830 directly or via a front housing portion surrounding the display (FIG. 15), as the case may be. The decoder 1814 receives signals from the detectors 1832, 1834, 1836, 1838 and provides information to the microprocessor 1804 as to the direction of movement of the display or housing portion surrounding the display. The decoder 1814 is also coupled to a keypad 1840 and processes key press information received from the keypad. For touch screen devices, a touch screen decoder is provided.

The D/A 1810 drives a speaker 1844 through a second amplifier 1842. The speaker 1844, which may be an external earphone speaker, serves as an audio output, e.g., for playing music.

FIG. 19 is flowchart 1900 of a method of operating an electronic device according to various embodiments. In block 1902 detectors for sensing a change in the position of the display screen (or front housing part surrounding the display screen) are read. Block 1904 is a decision block, the outcome of which depends on whether a leftward thrust of the display screen (or front housing part) was detected when the detectors were read in block 1902. If so then in block 1906 a track position of a sequence of music tracks being played is moved backwards to a preceding track. After executing block 1906 the flowchart returns to block 1902.

If the outcome of decision block 1904 is negative the flowchart branches to decision block 1908, the outcome of which depends on whether a rightward thrust of the display screen (or front housing part) was detected. If the outcome decision block 1908 is positive, then in block 1910 the track position is advanced forward to a next position. After executing block 1910 the flowchart returns to block 1902. If the outcome of decision block 1908 is negative then the flowchart 1900 branches to decision block 1912 the outcome of which depends whether an upward thrust of the display screen (or front housing part) was detected. If the outcome of block 1912 is positive then in block 1914 the volume of a current music track being played is increased. After executing block 1914 the flowchart returns to block 1902.

If the outcome of block 1912 is negative then the flowchart 1900 branches to decision block 1916 the outcome of which depends on whether a downward thrust of the display screen (or front housing part) was detected. If so, then in block 1918 the volume of the current music track being played is decreased. If the outcome of decision block 1916 is negative or in the case that it is positive after executing block 1918, the flowchart loops back to block 1902 to read the detectors again and proceeds as previously described. Note that while the flowchart 1900 describes functions that are performed in a serial fashion alternatively the various tests that are described can be performed in parallel. As mentioned previously, depending on the flow chart implementation, diagonal thrusts can be interpreted as two commands (one for each Cardinal thrust direction) or as a single command. Software that operates according to the flowchart 1900 is suitably stored in the program memory 1816 and executed by the processor 1804.

Note that the embodiments reside primarily in combinations of method steps and apparatus components related to ergonomic input mechanisms for electronic devices Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of ergonomic electronic device input mechanisms described herein. The non-processor circuits may include, but are not limited to, a radio receiver, a radio transmitter, signal drivers, clock circuits, power source circuits, and user input devices. As such, these functions may be interpreted as steps of a method to perform ergonomic electronic device input mechanisms. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A portable electronic device comprising:
a display;
a housing, including a rear housing part, supporting the display wherein the display is moveable relative to the rear housing part and wherein the display is biased to a neutral position;
at least one detector adapted to sense relative movement of the display from the neutral position in at least two different directions; and
a microprocessor adapted to receive a signal from the at least one detector and control the portable electronic device based on the signal.

2. The portable electronic device according to claim 1 wherein the display is moveable in an imaginary plane that includes the display.

3. The portable electronic device according to claim 1 wherein the display is moveable in a tilting motion.

4. The portable electronic device according to claim 3 wherein the display is moveable in a motion perpendicular to an imaginary plane that includes the display.

5. The portable electronic device according to claim 1 wherein the housing further comprises:
a front housing part which supports the display wherein the front housing part moves with the display.

6. The portable electronic device according to claim 1 wherein the housing further comprises:
a front housing part which supports the display wherein the display is moveable relative to the front housing part.

7. The portable electronic device according to claim 1 further comprising:
an audio output, and
wherein the portable electronic device is adapted to play a sequence of music tracks and the microprocessor is adapted to respond to the signal by affecting play of the sequence of music tracks.

8. The portable electronic device according to claim 7 wherein the microprocessor is adapted to respond to the signal by altering a volume setting.

9. The portable electronic device according to claim 7 wherein the microprocessor is adapted to respond to the signal by changing music tracks.

10. The portable electronic device according to claim 1 comprising:
a device for biasing the display to a central rest position.

11. The portable electronic device according to claim 10 wherein the device for biasing the display comprises:
a spring.

12. The portable electronic device according to claim 11 wherein the spring comprises:
a flat spiral shaped spring.

13. The portable electronic device according to claim 12 wherein the device for biasing the display further comprises:
a middle plate having a central opening adapted to accommodate the flat spiral shaped spring;
a second plate slidably coupled to the middle plate and adapted to slide relative to the middle plate in a first direction, the second plate comprising a first boss adapted to engage an inward end of the flat spiral shaped spring;
a third plate slidably coupled with the middle plate and adapted to slide relative to the middle plate in a second direction that is substantially perpendicular to the first direction, the third plate comprising a second boss adapted to engage a periphery of the flat spiral shaped spring.

14. A portable electronic device comprising:
a display;
a front housing part supporting the display that is moveable relative to a rear housing part;
a device for biasing the front housing part to a neutral position;
at least one detector adapted to sense relative movement of the front housing part from the neutral position in at least two different directions; and
a microprocessor adapted to receive a signal from the at least one detector and control the portable electronic device based on the signal.

15. The portable electronic device according to claim 14 wherein the front housing part is moveable in an imaginary plane that is parallel to the display.

16. The portable electronic device according to claim 14 further comprising:
an audio output,
wherein the portable electronic device is adapted to play a sequence of music tracks and the microprocessor is adapted to respond to the signal by affecting play of the sequence of music tracks.

17. The portable electronic device according to claim 16 wherein the microprocessor is adapted to respond to the signal by altering a volume setting.

18. The portable electronic device according to claim 16 wherein the microprocessor is adapted to respond to the signal by changing music tracks.

19. A method of operating a portable electronic device comprising:
detecting a user input to the portable electronic device in a form of movement of a display of the portable electronic device relative to a rear housing part of the portable electronic device in one of at least two directions from a neutral position; and
responding to the user input by altering a manner in which the portable electronic device is operating.

20. A method of operating a portable electronic device according to claim 19 further comprising:
automatically returning the display to the neutral position.
